(19) United States
(12) Patent Application Publication
(10) Pub. No.: US 2012/0194156 A1
(43) Pub. Date: Aug. 2, 2012

(54) LOAD DRIVING SIGNAL-LINKED HIGH VOLTAGE DRIVING METHOD AND DRIVING CIRCUIT THEREOF

(76) Inventors: Junhyeong Myoung, Seoul (KR); Duhwan Sa, Hwaseong-si (KR); Jinguk Lee, Yongin-si (KR); Seonguk Park, Yongin-si (KR)

(21) Appl. No.: 13/499,728

(22) PCT Filed: Apr. 15, 2010
(86) PCT No.: PCT/KR10/02356

§ 371 Date: Apr. 2, 2012

(30) Foreign Application Priority Data
Oct. 12, 2009 (KR) 10-2009-0096679

(51) Int. Cl. G05F 1/00; G05F 1/10

(52) U.S. Cl. 323/282; 323/234

(57) ABSTRACT

A load driving signal-linked high voltage driving method comprises the steps of: generating an output power voltage of preset size by boosting the voltage of input power; converting the output power voltage so that the generated output power voltage may be linked with an output signal of a load driving circuit; and driving a load by applying the converted output power voltage to the load driving circuit. According to the above present invention, it is possible to minimize power consumption of a battery in a portable electronic device which drives a load by converting the low-voltage rectification power or a voltage of the battery into a high voltage, and thus the usage of a function or an apparatus such as a haptic terminal or the like, which may need a high voltage, is more activated.

### BACKGROUND OF THE INVENTION

The present invention relates to a load driving signal-linked high voltage driving method and a driving circuit thereof, more particularly to a load driving signal-linked high voltage driving method and a driving circuit thereof in that it generates an output power voltage linked with a size of a signal for operating the load, whereby minimizing the power consumption thereof.

Recently, there is much case that various electronic products such as a portable terminal etc. are provided with the haptic function for delivering the feedback to a user by using a vibrator such as a vibrating motor or a piezoelectric element etc. That is, the information of the other feeling is delivered to the user by stimulating a tactile signal as well as the information is transferred to the user through sight and hearing. In this signal transduction, there is much case that the vibrator etc., which is driven in a high voltage more than a low voltage power supplied from the portable electronic instrument, is utilized.

In such a drive of the high voltage, it is implemented by the mode that the high voltage is generated from the voltage level (3˜4V) of the battery used in the portable electronic instrument and then, the generated high voltage is supplied as the power voltage thereof, so that the load driving signal is supplied to the vibrator to be driven.

However, this technology has a defect in that the consumption of electricity is big, thereby remarkably increasing the battery consumption of the portable product in the course of generating the high voltage.

Generally, in the high voltage generating circuit, the electricity power consumption of being consumed in the battery is calculated as the multiplication of the output power voltage of a predetermined value and the consumption current since it produces the voltage more than the highest point of the load driving signal and it allows the generated voltages of the highest point to supply to the load driving circuit. Actually, in the load driving signal for driving the load, since there are frequent occasions that the size of the voltage thereof is variable, it requires electrical energy consumptions more than the electrical power necessary for driving the actual load.

### SUMMARY OF THE INVENTION

Therefore, the present invention has been made in view of the above-mentioned problems, and the object of the present invention is to provide a load driving signal-linked high voltage driving method and a driving circuit thereof, in that it generates an output power voltage linked with a size of a signal for operating the load, so that the power consumption thereof can be minimized for applying to the portable electronic products.

In accordance with the present invention to achieve the object thereof, there is provided a load driving signal-linked high voltage driving method comprising the steps of: generating an output power voltage of preset size by boosting a voltage of an input power; converting the output power voltage so that the generated output power voltage may be linked with an output signal of a load driving circuit; and driving a load by applying the converted output power voltage to the load driving circuit.

Here, in the step of converting the output power voltage so that the generated output power voltage may be linked with an output signal of a load driving circuit, it compares a power control signal identical with or related to the input signal of the load driving circuit with the output power voltage, so that the output power voltage is converted in such a manner that it follows the power control signal.

In accordance with the present invention to achieve the object thereof, there is provided a load driving signal-linked high voltage driving circuit comprising: a high voltage converting unit for boosting an input power to an output power voltage of preset size and supplying it to a load driving circuit; a sensor for sensing the output power voltage of the high voltage converting unit through a feedback; a comparator for comparing the voltage sensed in the sensor with the power control signal; and a driving controller for outputting a switching control signal corresponding to the output signal of the comparator so as to switching-control the operation of the high voltage converting unit and linking the output power voltage of the high voltage converting unit with the output signal of the load driving circuit.

Here, the power control signal is identical with or related to the input signal of the load driving circuit.

Also, the load driving circuit is an amplifier, the load is a vibrator, and the input power is a power of a battery.

According to the load driving signal-linked high voltage driving method and the driving circuit thereof, in the portable electronic instruments for converting the voltage of the battery into the high voltage to drive the load, it is possible to minimize power consumption of the battery in the portable electronic device which drives the load by converting the voltage of the battery into the high voltage, and thus the usage of a function or an apparatus such as the haptic terminal or the like, which may need the high voltage, is more activated.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is an explaining view illustrating principles of driving a vibrator through an output power voltage generated by a load driving signal-linked high voltage driving method according to the present invention;

FIG. 2 is a block diagram illustrating to a load driving signal-linked high voltage driving circuit according to the present invention; and

FIG. 3 shows the correlation between four signals used in FIG. 2.

<Descriptions on reference numbers for the
major components in the drawings>

| | |
|---|---|
| 10: high voltage converting unit | 20: sensor |
| 30: comparator | 40: driving controller |
| 50: switch | 60: load driving circuit |

### DETAILED DESCRIPTION OF THE INVENTION

Hereinafter, exemplary embodiments of the present invention will be described in detail with reference to the accompanying drawings.

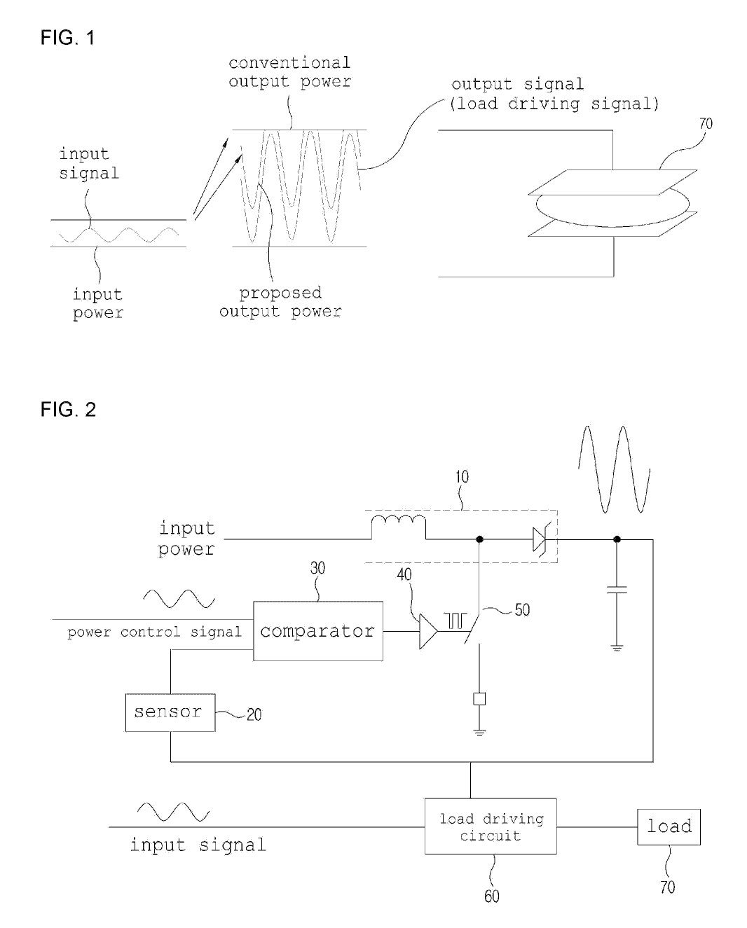

FIG. 1 is an explaining view illustrating principles of driving a vibrator through an output power voltage generated by a load driving signal-linked high voltage driving method according to the present invention.

The waveform of the left side in FIG. 1 represents an input signal of the load driving circuit and an input power outputted from a battery. Also, the waveform of the right side thereof illustrates an output power of the high voltage of boosting the input power and an output signal of the load driving circuit of amplifying the input signal through an amplifier etc.

Here, as shown in the right side waveform of FIG. 1, it can be found that the conventional output power has a fixed value as any signal of boosting the input power. Also, as described above, the unnecessary power consumption is generated.

Accordingly, as indicated by the output power proposed in the right side waveform of FIG. 2 according to the present invention, it does not have the value in which the output power is fixed. However, it is characterized in that the electrical energy consumption is minimized by consecutively varying the instantaneous value of the electrical energy consumption in order that the output power is linked with the output signal (load driving signal) to be varied.

That is, as to the output power generation, the voltages as needed for load driving are generated in each point of time to be supplied.

In FIG. 1, the vibrator 70 for the tactile signal generation is illustrated. However, instead of it, various loads of demanding the high voltage, which are higher than the normal battery voltage, can be used.

FIG. 2 is a block diagram illustrating to a load driving signal-linked high voltage driving circuit according to the present invention.

As shown in FIG. 2, the load driving signal-linked high voltage driving circuit according to the present invention includes a high voltage converting unit 10, sensor 20, and a comparator 30, and driving controller 40.

The high voltage converting unit 10 serves to generate an output power voltage of preset size by boosting the voltage of input power outputted from a battery and supply it to a driving circuit 60. The normal DC-DC converter including a transformer and Zener diode etc. can be used

The sensor 20 includes an input terminal connected to an output terminal of the high voltage converting unit 10 so as to detect the output signal of the high voltage converting unit 10, that is, the output power voltage. A voltage divider using a resistance can be used. In order to fit for the rated voltage of the comparator 30 connected to the rear end of the voltage divider, it serves to drop the output power voltage to scale to be outputted.

The comparator 30 serves to compare the voltage sensed in the sensor 20 with the power control signal and output any signal in proportion to the difference of two signals. Here, the power control signal is identical with or related to the input signal of the load driving circuit 60.

The driving controller 40 serves to output a switching control signal corresponding to the output signal of the comparator 30 to a PWM or PFM mode and link the output power outputted from the high voltage converting unit 10 with the output signal of the load driving circuit 60 by controlling the switch 50 connected to a rear end thereof.

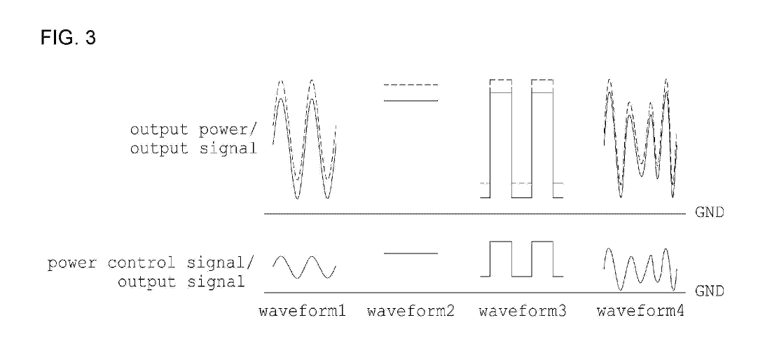

FIG. 3 shows the correlation between four signals used in FIG. 2.

Referring to FIG. 3, it can be seen that the output power, which supplied to the load driving circuit 60, is variably outputted in such a manner that the value of the output power is a litter higher than that of the output signal outputted from the load driving circuit 60. Here, it needs to pay attention that the output power follows the output signal regardless of the waveform of the output signal.

Also, as shown FIG. 3, it is desirable that the power control signal is identical with the input signal inputted to the load driving circuit 60. However, although they are not identical, both signals are related to each other, so that the output power is linked with the output signal and it will be sufficient.

Hereinafter, the operation of a load driving signal-linked high voltage driving circuit according to the present invention will be described with reference to FIG. 1 through FIG. 3. In the following description, the load driving circuit 60 is an amplifier and the load 70 is a vibrator such as a vibrating motor etc.

The input signal, which is inputted to the amplifier 60, is the vibration pattern signal for vibrating the vibrator to the specific pattern. The amplitude and frequency thereof can be consecutively varied as a sinusoidal wave or a square wave etc. The output signal amplified in a predetermined size by the amplifier 60 is supplied to the vibrator 70 connected to the rear end of the amplifier 60, so that the vibrator 70 is vibrated to the pattern corresponding to the pattern of the output signal.

The high voltage converting unit 10 serves to generate the output power voltage by boosting the power voltage of the battery in a predetermined size fit for the operation voltage of the vibrator 70 and supply it as the operation voltage of the amplifier 60. The generated output voltage is fed back through the sensor 20 and the output power is linked with the output signal of the amplifier 60 through the control operation of the driving controller 40 and the comparator 30.

Here, if it makes the power control signal and the input signal identically and it sets up in such a manner that the gain of the amplifier 60 and the voltage drop rate of the sensor 20 are in inverse proportion to each other, the output power, which is automatically controlled and outputted with the feedback, can be linked with the output signal of the amplifier 60.

Although several exemplary embodiments of the present invention have been described for illustrative purposes, those skilled in the art will appreciate that various modifications, additions and substitutions are possible, without departing from the scope and spirit of the invention as disclosed in the accompanying claims.

The present invention relates to a load driving signal-linked high voltage driving method and a driving circuit thereof in that it generates an output power voltage linked with a size of a signal for operating the load, whereby minimizing the power consumption thereof.

1. A load driving signal-linked high voltage driving method comprising the steps of:
generating an output power voltage of preset size by boosting a voltage of an input power;
converting the output power voltage so that the generated output power voltage may be linked with an output signal of a load driving circuit; and
driving a load by applying the converted output power voltage to the load driving circuit.

2. A load driving signal-linked high voltage driving method as recited in claim 1, wherein, in the step of converting the output power voltage so that the generated output power voltage may be linked with an output signal of a load driving circuit, it compares a power control signal identical with or related to the input signal of the load driving circuit with the output power voltage, so that the output power voltage is converted in such a manner that it follows the power control signal.

3. A load driving signal-linked high voltage driving circuit comprising:
a high voltage converting unit for boosting an input power to an output power voltage of preset size and supplying it to a load driving circuit;
a sensor for sensing the output power voltage of the high voltage converting unit through a feedback;
a comparator for comparing the voltage sensed in the sensor with the power control signal; and
a driving controller for outputting a switching control signal corresponding to the output signal of the comparator so as to switching-control the operation of the high voltage converting unit and linking the output power voltage of the high voltage converting unit with the output signal of the load driving circuit.

4. A load driving signal-linked high voltage driving circuit as recited in claim 3, wherein the power control signal is identical with or related to the input signal of the load driving circuit.

5. A load driving signal-linked high voltage driving circuit as recited in claim 3, wherein the load driving circuit is an amplifier and the load is a vibrator.

6. A load driving signal-linked high voltage driving circuit as recited in claim 3, wherein the input power is a power of a battery.
